(19) United States
(12) Patent Application Publication
(10) Pub. No.: US 2009/0054470 A1
(43) Pub. Date: Feb. 26, 2009

(54) USE OF MITOCHONDRIAL ELECTRON TRANSPORT INHIBITORS TO CONTROL FOULING ORGANISMS

(76) Inventors: Jan Pieter Hendrik Bosselaers, Beerse (BE); Dany Leopold Jozefien Bylemans, Beerse (BE)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/908,665

(22) PCT Filed: Mar. 15, 2006
(86) PCT No.: PCT/EP06/60725

§ 371 Date: May 13, 2008

(30) Foreign Application Priority Data
Mar. 15, 2005 (EP) 05101999.0

(51) Int. Cl. A01N 43/58; A01N 43/54; A01N 43/56; A01P 13/00; A01P 1/00; A01P 9/00

(52) U.S. Cl. 514/266.3; 514/247; 514/406

(57) ABSTRACT

The present invention relates to the use of mitochondrial electron transport inhibitors (METI's) to control or combat fouling organisms. More particularly, the present invention relates to the use of mitochondrial electron transport inhibitors for protecting materials against fouling by marine or freshwater fouling organisms and an antifouling composition suitable for use therefore. This invention thus relates to the field of protection of materials that are exposed to humid or aqueous environments.

The present invention relates to the use of mitochondrial electron transport inhibitors (METI's) to control or combat fouling organisms. More particularly, the present invention relates to the use of mitochondrial electron transport inhibitors for protecting materials against fouling by marine or freshwater fouling organisms and an antifouling composition suitable for use therefore. This invention thus relates to the field of protection of materials that are exposed to humid or aqueous environments.

Surfaces or objects exposed to humid or aqueous environments are readily colonized by aquatic organisms such as algae, fungi, bacteria, microbes, and aquatic animals such as, e.g. tunicates, hydroids, bivalves, bryozoans, polychaete worms, sponges, barnacles, molluscs and crustacea. As these organisms settle on or attach to said surfaces, the value of the exposed objects diminishes. The attachment or settlement of said organisms is also known as ‘fouling’ of a structure. The exterior, but possibly also the interior of the object may deteriorate, the surface changes, e.g. from smooth, clean and streamlined to rough, foul and turbulent, the weight of the object increases by the deposit of the organisms and their remnants, and the vicinity of the object may become obstructed or encumbered. The function of the object and system involved lowers and the quality of the aqueous environment deteriorates. The common method of controlling the attachment of fouling organisms is by treating the structure to be protected with a coating which comprises an antifouling agent.

Mitochondrial electron transport inhibitors (METI's) as defined in the present invention are compounds that bind to the complex I coenzyme site Q thereby blocking cellular respiration. These compounds are also known as “complex I mitochondrial electron transport inhibitors”. Art known examples are fenazaquin, fenpyroximate, piericidin A, pyridaben, pyrimidifen, rotenone, tebufenpyrad, and tolfenpyrad. The latter compounds are being used as acaricides and are also referred to as “METI acaricides”.

US-2003/114312 discloses combinations of cyclic ketoenol compounds with other known active compounds having insecticidal and acaricidal properties including compounds such as tebufenpyrad, pyridaben, fenpyroximate, fenazaquin and pyrimidifen. Said combinations are described as being useful for controlling animal pests and plant pests, for the protection of industrial materials against insects and for antifouling purposes. No data are presented to support these utilities.

EP-0,922,386 discloses controlled release compositions comprising biologically active compounds. The biologically active compounds are choosen from microbicides, marine antifouling agents or agricultural pesticides including agricultural fungicides, herbicides, insecticides and miticides. The compounds pyridaben and rotenone are mentioned as examples of suitable insecticides.

It has now been found that METI's, i.e. complex I mitochondrial electron transport inhibitors, are effective as antifouling agents.

The structural formulae of some art known complex I mitochondrial electron transport inhibitors are listed below

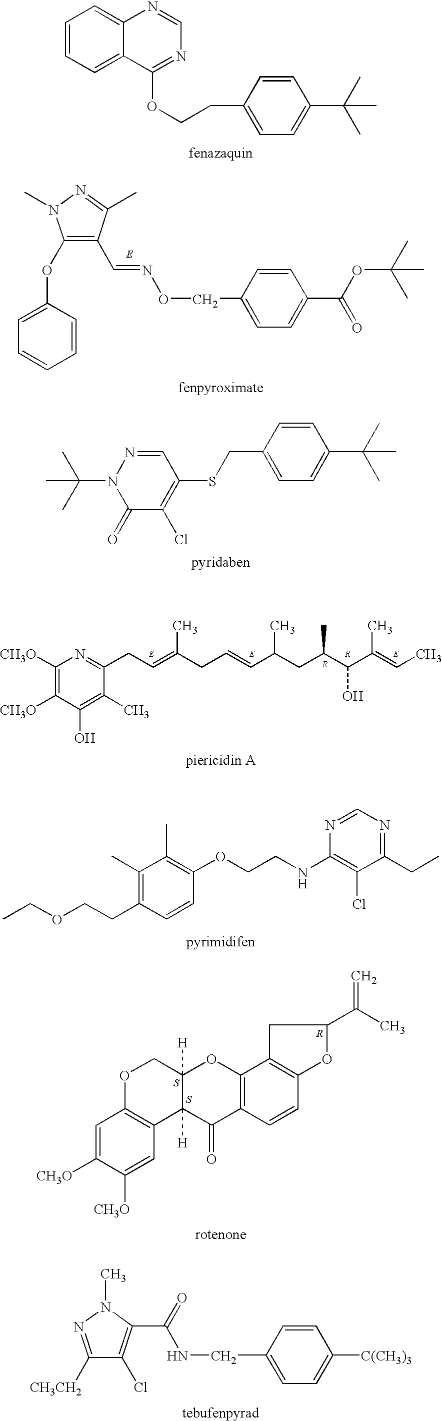

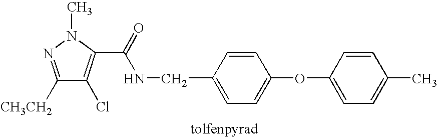

Wherever the term “mitochondrial electron transport inhibitors”, “METI”, “METI's”, or “one or more mitochondrial electron transport inhibitors” is used, it is meant to include a mitochondrial electron transport inhibitor both in its base or in its salt form, the latter being obtained by reaction of the base form with an appropriate acid. Appropriate acids comprise, for example, inorganic acids, such as the hydrohalic acids, i.e. hydrofluoric, hydrochloric, hydrobromic and hydroiodic, sulfuric acid, nitric acid, phosphoric acid, phosphinic acid and the like; or organic acids, such as, for example, acetic, propanoic, hydroxyacetic, 2-hydroxypropanoic, 2-oxopropanoic, ethanedioic, propanedioic, butanedioic, (Z)-2-butenedioic, (E)-2-butenedioic, 2-hydroxybutanedioic, 2,3-dihydroxybutanedioic, 2-hydroxy-1,2,3-propanetricarboxylic, methanesulfonic, ethanesulfonic, benzenesulfonic, 4-methyl-benzenesulfonic, cyclohexanesulfamic, 2-hydroxybenzoic, 4-amino-2-hydroxybenzoic and the like acids. Mitochondrial electron transport inhibitors may also exist in the form of solvates, such as hydrates.

As used herein, the term “antifouling agent” shall mean a product that kills or inhibits the growth, reproduction, or spread of fouling organisms. An “antifouling effective amount” of an antifouling agent is that amount that will kill or inhibit the growth, reproduction or spread of a significant number of fouling organisms. The term “control” or “combat” is defined to mean inhibiting the growth, reproduction or spread of fouling organisms.

The term “fouling organisms” is meant to comprise organisms that attach, settle, grow on or adhere to various kinds of surfaces, in particular in humid or aqueous environments such as, marine waters, fresh waters, brackish waters, rain water, and also cooling water, drainage water, waste water and sewage. Fouling organisms are Algae such as, for example, Microalgae, e.g. Amphora, Achnanthes, Navicula, Amphiprora, Melosira, Cocconeis, Chlamydomonas, Chlorella, Ulothrix, Anabaena, Phaeodactylum, Porphyridium; Macroalgae, e.g. Enteromorpha, Cladophora, Ectocarpus, Acrochaetium, Ceramium, Polysiphonia and Hormidium sp.; fungi; microbes; tunicates, including members of the class Ascidiacea such as Ascidiella aspersa, Ascidiella scabra, Ciona intestinalis, Dendrodoa grossularia, Diplosoma listerianium, Styela clava, and Botryllus schlosseri; members of the class Hydrozoa, including Clava squamata, Hydractinia echinata, Obelia geniculata and Tubularia larynx; bivalves, including Mytilus edulis, Crassostrea virginica, Ostrea edulis, Ostrea chilensia, Dreissena polymorpha (zebra mussels) and Lasaea rubra; bryozoans, including Electra pilosa, Bugula neritina, and Bowerbankia gracilis; polychaete worms, including Hydroides norvegica; sponges; and members of the class Crustacea, including Artemia, and Cirripedia (barnacles), such as Balanus amphitrite, Lepas anatifera, Balanus balanus, Balanus balanoides, Balanus hameri, Balanus crenatus, Balanus improvisus, Balanus galeatus, and Balanus eburneus; and Elminius modestus, and Verruca.

The present invention provides a method for controlling or combatting marine or freshwater fouling organisms which comprises contacting said organism with an antifouling-effective amount of a METI, or a composition comprising an antifouling-effective amount of a METI.

The present invention further provides a method of protecting a surface which comprises applying to the surface an antifouling composition comprising one or more mitochondrial electron transport inhibitors. An especially important use of the method of the invention comprises a method for inhibiting fouling of a ship's hull, which comprises applying to the hull an antifouling composition in accordance with the invention.

In practice the mitochondrial electron transport inhibitors may be brought into contact with the fouling organisms by
a) coating the aquatic structure to be protected with an antifouling effective amount of one or more METI's such that said antifouling agent is released into the aquatic environment immediately adjacent the external surface of said structure,
b) including an antifouling effective amount of one or more METI's within material formed into an aquatic structure which then releases said antifouling agent,
c) releasing an antifouling effective amount of one or more METI's directly into the aquatic environment surrounding the structure to be protected, or
d) any other method wherein the METI comes in contact with the fouling organisms.

The mitochondrial electron transport inhibitors are also useful to control or combat free-floating or free-swimming fouling organisms and may be of use in ballast water treatment systems to render ballast water free of contaminating organisms.

Compositions comprising a METI are suitable to protect surfaces or objects in constant or frequent contact with water from fouling, by applying to said surfaces or objects an antifouling composition comprising a METI. Examples of said surfaces or objects are for instance, shiphulls, harbor installations, piers and pilings, drying docks, sluice-gates, locks, mooring masts, buoys, offshore oil rigging equipment, drilling platforms, bridges, pipelines, fishing nets, cables, ballast water tanks, ship reservoirs that draw water from infested bodies of water, recreational equipment, such as surfboards, jet skis, and water skis, and any other object in constant or frequent contact with water.

Further, antifouling compositions in accordance with the invention can be used to protect constructions such as, e.g. swimming pools, baths, cooling water circulation circuits and industrial baths in various installations, e.g. in manufacturing plants or in air-conditioning installations, the function of which can be impaired by the presence and/or the multiplication of fouling organisms. Further examples are buildings and parts of buildings such as floors, outer and inner walls or ceilings, or places suffering from dampness such as cellars, bathrooms, kitchens, washing houses and the like, and which are hot-beds for fouling. Fouling not only is problematic from the viewpoint of hygiene and aesthetics, but also causes economic losses because said buildings and/or decorating materials deteriorate more rapidly than desired.

Compositions comprising a mitochondrial electron transport inhibitor can also be used in a variety of applications:
industrial aqueous process fluids, e.g. cooling waters, pulp and papermill process waters and suspensions, secondary oil recovery systems, spinning fluids, metal working fluids, and the like
in-tank/in-can protection of aqueous functional fluids, e.g. polymer emulsions, water based paints and adhesives, glues, starch slurries, thickener solutions, gelatine, wax emulsions, inks, polishes, pigment and mineral slurries, rubber latexes, concrete additives, drilling muds, toiletries, aqueous cosmetic formulations, pharmaceutical formulations, and the like.

The amount of mitochondrial electron transport inhibitor in the compositions according to the present invention will vary according to the specific compound used, the identity of the fouling organism to be controlled, degree of infestation of the surronding aquatic environment, the water temperature, the mode of contact and the like. In many instances the antifouling compositions to be used directly can be obtained from concentrates, such as e.g. emulsifiable concentrates, suspension concentrates, or soluble concentrates, upon dilution with aqueous or organic media, such concentrates being intended to be covered by the term composition as used in the definitions of the present invention. Such concentrates can be diluted to a ready to use mixture in a tank shortly before use.

Compositions comprising mitochondrial electron transport inhibitors as antifouling agents further suitably comprise carriers and additives, including wetting agents, dispersing agents, stickers, adhesives, emulsifying agents and the like such as those conventionally employed in the art of formulation. The antifouling compositions of the present invention may be prepared in any known manner, for instance by homogeneously mixing, coating and/or grinding the combination of antifouling agent, in a one-step or multi-steps procedure, with the selected carrier material and, where appropriate, the other additives such as surface-active agents.

Examples of inert carrier materials suitable for use as solid carriers in the present invention, e.g. for dust concentrates and granular formulations, include natural and synthetic mineral fillers, for instance magnesium silicates such as talc; silica such as diatomaceous earth; aluminium silicate such as kaolinite, montmorillonite or mica; magnesium aluminium silicate such as attapulgite and vermiculite; calcium carbonate and calcium sulphate; carbon such as charcoal; sulphur; and highly dispersed silicic acid polymers. Suitable granulated absorbent carrier materials may be porous, for example pumice, broken brick, sepiolite or bentonite. In addition, a great number of pre-granulated materials or inorganic or organic nature can be used, e.g. especially dolomite or pulverised plant residues. Other inert carrier materials suitable for use as organic solid carriers include natural and synthetic resins (whether crude or formulated), for example organic waste polymeric products such as polyvinyl chloride, polyethylene, polypropylene, polyacrylates such as polymethylmethacrylate, polystyrene and mixed polymerisates thereof.

The present invention also provides protective compositions, for instance in the form of paints, coatings or varnishes, comprising one or more mitochondrial electron transport inhibitors together with one or more additives suitable for their formulation. The amount of mitochondrial electron transport inhibitors in such protective compositions may range from 1 to 40% (w/v). Suitable additives for use in said protective compositions are quite conventional in the art and include, for instance, at least an organic binder (preferably in aqueous form) such as an acrylic or vinyl-based emulsion; mineral carriers such as calcium carbonate; surface-active agents such as previously described with respect to the formulation of agronomic compositions; viscosity regulators; corrosion inhibitors; pigments such as titanium dioxide; stabilisers such as sodium benzoate, sodium hexametaphosphate and sodium nitrite; mineral or organic colorants and the like. The ways of formulating such additives together with the mitochondrial electron transport inhibitors is also well within the knowledge of those skilled in the art. Such protective compositions may be used not only to cure and/or limit the damaging effects of fouling organisms but also in order to prevent deterioration to occur on materials which may be subjected to the harmful environment and effects of fouling organisms.

Other appropriate additives for use in the antifouling compositions of the present invention may be solid or liquid and are suitable substances known in the art for preparing formulations for treating surfaces or objects exposed to humid or aqueous environments, while providing a further protective effect namely for storing and handling purposes. Such additives may comprise, for example, polymers or copolymers, resins, and other optional additives such as, water-repelling agents; surface slipping agents; diluents; organic binding agents; insecticides; fungicides; bactericides; auxiliary solvents; processing additives; fixatives; thickening agents; plasticizers; UV-stabilizers; stabilisers against heat or light; dyes; color pigments; siccatives; corrosion inhibitors; antisettling agents; anti-skinning agents; and antifoaming agents and the like.

The antifouling compositions according to the present invention can be applied by a number of conventional methods, such as hydraulic spray, air-blast spray, aerial spray, atomising, dusting, scattering or pouring. The most appropriate method will be chosen by those skilled in the art in accordance with the intended objectives and the prevailing circumstances, namely the kind of fouling organism to be controlled, the type of equipment available and the type of material to be protected.

### Evaluation of Antifouling Activity of Test Compounds

1. In Vitro Efficacy Against Artemia salina

The crustaceous marine animal Artemia salina was used as a model organism for other marine fouling organisms.

An artificial seawater medium inoculated with approximately 30 Artemia salina instar II larvae was introcuced in each well of a 24 well microtiter plate (2 ml per well). This culture was incubated with the test compound dissolved in dimethylsulfoxide (8000 ppm stock solution in DMSO) in order to have a final concentration of the test compound ranging from 0.027 ppm to 20 ppm in 24 steps. Survival of the Artemia salina larvae was evaluated after 24 and 48 hours. Zinc pyrithione was used as a reference art known antifouling agent and a DMSO solution without test compound was used as control.

The MIC value (in mg/ml=ppm): lowest concentration of the test compound at which strong activity (all Artemia salina larvae dead) was observed and has been listed below in Table 1.

The ECX value (in mg/ml=ppm): lowest concentration of the test compound at which moderate activity (reduced vitality of Artemia salina larvae) was observed and has been listed below in Table 1.

TABLE 1
Dose results for the mitochondrial electron transport inhibitors
fenazaquin, pyridaben and tebufenpyrad against Artemia
salina. MIC and ECX values in mg/l (=ppm)

| Test Compounds | | 24 hours | 48 hours |
|---|---|---|---|
| fenazaquin | MIC | 1.5 | 1.5 |
| | ECX | 0.84 | 0.84 |
| pyridaben | MIC | 2 | 0.48 |
| | ECX | 0.36 | 0.36 |
| tebufenpyrad | MIC | 2 | 1.5 |
| | ECX | 1.13 | 0.84 |
| Zinc pyrithione | MIC | 20 | 11.25 |
| | ECX | 8.44 | 6.33 |
| Control | MIC | >20 | >20 |
| | ECX | >20 | >20 |

### 2. Field Evaluation of Marine Antifouling Activity

In this evaluation the test compounds were formulated in a vinylite or rosin paint formulation and coated on PVC boards which were then immersed in sea water (Oosterschelde) and raised intermittently over a period of 12 weeks to evaluate the surface fouling.

Composition vinylite paint (% w/w): 9.1% test compound (74% in the dried coating), 3.2% vinylite, 87.7% cyclohexanone.

Composition rosin paint (% w/w): 6.7% test compound (18.4% in the dried coating), 34.9% rosin (69.6% in xylene), 6.3% vinyl resin, 5.7% tritolyl phosphate, 45.0% methyl isobutylketone and 1.4% xylene.

The PVC boards (10×2×0.5 cm) were painted twice to obtain a coating layer of 140 g/m² having a thickness of 50 μm and dried for two weeks before immersion in sea water. The exact quantity of test compound on each board was determined by comparing the initial and final weights of the PVC boards. The PVC boards were placed in a frame and suspended from the bottom of a raft at a depth of 0.6 m below the sea water surface level.

Rating system to evaluate surface fouling:

score 0: no growth on the panel
score 1: up to 20% of the surface covered by fouling organisms
score 2: between 21% and 40% of the surface covered by fouling organisms
score 3: between 41% and 60% of the surface covered by fouling organisms
score 4: between 61% and 80% of the surface covered by fouling organisms
score 5: more than 81% of the surface covered by fouling organisms

TABLE 2
Efficacy against animal fouling of test compounds exposed in the
Oosterschelde at Bruinisse (vinylite paint on PVC panels)

| | Fouling scores after x weeks | | |
|---|---|---|---|
| Test compound | 4 weeks | 8 weeks | 15 weeks |
| fenazaquin | 0 | 0 | 3 |
| talc (placebo) | 2 | 5 | 5 |

Figures are an average of two scores (back and front of test panel).

TABLE 3
Efficacy against animal fouling of test compounds exposed in the
Oosterschelde at Bruinisse (rosin paint on PVC panels)

| Test compound | Fouling scores after 12 weeks |
|---|---|
| pyridaben | 1.5 |
| tebufenpyrad | 1.5 |
| talc (placebo) | 3.5 |

Figures are an average of two scores (back and front of test panel).

1. A method for controlling or combatting marine or freshwater fouling organisms which comprises contacting said organism with a complex I mitochondrial electron transport inhibitor (METI).

2. A method as claimed in claim 1 wherein the METI is selected from the group consisting of fenazaquin, fenpyroximate, piericidin A, pyridaben, pyrimidifen, rotenone, tebufenpyrad, and tolfenpyrad.

3. A method as claimed in claim 2 wherein the METI is fenazaquin.

4. A method as claimed in claim 2 wherein the METI is pyridaben.

5. A method as claimed in claim 2 wherein the METI is tebufenpyrad.

6. A method according to any of claims 1 to 5 wherein the fouling organisms are free-floating or free-swimming in ballast water.

7. A method of protecting surfaces or objects in constant or frequent contact with water from fouling which comprises applying to said surface or object an antifouling composition comprising one or more mitochondrial electron transport inhibitors as defined in any of claims 1 to 5.

8. A method according to claim 7 wherein said surfaces or objects are shiphulls, harbor installations, piers and pilings, drying docks, sluice-gates, locks, mooring masts, buoys, offshore oil rigging equipment, drilling platforms, bridges, pipelines, fishing nets, cables, ballast water tanks, ship reservoirs that draw water from infested bodies of water, recreational equipment, such as surfboards, jet skis, and water skis, and any other object in constant or frequent contact with water.

9. A method according to claim 7 or 8 wherein the composition is in the form of an emulsifiable concentrate, suspension concentrate, or soluble concentrate.

10. A method according to claim 7 or 8 wherein the composition is in the form of a paint, a coating or a varnish.
